(19) United States
(12) Patent Application Publication
(10) Pub. No.: US 2026/0322256 A1
(43) Pub. Date: Oct. 15, 2026

(54) TOTEM-POLE POWER FACTOR CORRECTION CIRCUIT AND ASSOCIATED POWER CONVERSION DEVICE

(71) Applicant: Delta Electronics, Inc., Taoyuan City (TW)

(72) Inventors: Feng-Hsuan Tung, Taoyuan City (TW); Shu-Zheng Huang, Taoyuan City (TW); Chia-Hsiong Huang, Taoyuan City (TW); Yi-Hsun Chiu, Taoyuan City (TW)

(21) Appl. No.: 19/227,237

(22) Filed: Jun. 3, 2025

(30) Foreign Application Priority Data
Apr. 11, 2025 (CN) 202510452878.7

(51) Int. Cl. H02M 1/42; H02M 1/00

(52) U.S. Cl. CPC H02M 1/4233; H02M 1/0029; H02M 1/0038; H02M 1/0058

(57) ABSTRACT

A totem-pole power factor correction circuit includes a fast upper switch, a fast lower switch, a slow upper switch, a slow lower switch, a capacitor filter circuit and a controller. The slow upper switch and the slow lower switch are electrically connected with a node. There is a terminal voltage between the node and a reference potential point. The controller outputs control signals to control operations of the fast upper switch, the fast lower switch, the slow upper switch and the slow lower switch. If an input voltage is within a zero-crossing interval, the controller controls the operations of the fast upper switch and the fast lower switch according to a predetermined voltage slope and the terminal voltage. Consequently, the change rate of the terminal voltage is adjusted according to the predetermined voltage slope.

### CROSS-REFERENCE TO RELATED APPLICATION

This application claims priority to China Patent Application No. 202510452878.7, filed on April 11, 2025. The entirety of the above-mentioned patent application is incorporated herein by reference for all purposes.

### FIELD OF THE INVENTION

The present disclosure relates to a power factor correction circuit, and more particularly to a totem-pole power factor correction circuit and an associated power conversion device capable of suppressing leakage current.

### BACKGROUND OF THE INVENTION

Nowadays, the power factor correction technology is developed toward greater efficiency and greater power density while reducing energy loss and improving overall system performance. For example, a totem-pole power factor correction circuit is one of the widely used factor correction circuits.

When the AC input voltage is in the zero-crossing region (for example, the voltage range is near 0V, in the transition region from the negative voltage to the positive voltage through 0V, or in the transition region from the positive voltage to the negative voltage through 0V), a high leakage current spike tends to occur in the totem-pole power factor correction circuit when the slow leg circuit is conducted. Consequently, the power conversion device using the totem-pole power factor correction circuit causes the leakage current to exceed regulatory limits, potentially leading to hazards. For example, the hazards include electric shock to users due to current leakage through the external casing, device damage, or even fire. Furthermore, the design of the totem-pole power factor correction circuit is limited.

### SUMMARY OF THE INVENTION

The present disclosure provides a totem-pole power factor correction circuit and an associated power conversion device in order to effectively suppress leakage current and address other defects.

In accordance with an aspect of the present disclosure, a totem-pole power factor correction circuit is provided. The totem-pole power factor correction circuit receives an input voltage and an input current and accordingly provides an output voltage and an output current. The totem-pole power factor correction circuit includes a fast arm circuit, a slow arm circuit, a capacitor filter circuit and a controller. The fast arm circuit includes a fast upper switch and a fast lower switch connected in series. The slow arm circuit includes a slow upper switch and a slow lower switch connected in series. The slow upper switch and the slow lower switch are electrically connected with a node. In addition, there is a terminal voltage between the node and a reference potential point. The capacitor filter circuit is electrically connected with the fast arm circuit and the slow arm circuit. The capacitor filter circuit has an equivalent capacitance value. The controller is electrically connected with the fast arm circuit and the slow arm circuit. The controller outputs a first control signal, a second control signal, a third control signal and a fourth control signal to respectively control operations of the fast upper switch, the fast lower switch, the slow upper switch and the slow lower switch. If the input voltage is greater than a first threshold value and lower than a second threshold value when the input voltage changes from a negative value to zero, the fast upper switch, the slow upper switch and the slow lower switch are not conducted according to the first control signal, the third control signal and the fourth control signal set by the controller, and at least one of a reference voltage command and a reference current command is increased by the controller. In addition, a duty cycle of the second control signal is gradually increased, and the fast lower switch is intermittently conducted. Consequently, a change rate of the terminal voltage is adjusted according to a predetermined voltage slope. If the input voltage is greater than the first threshold value and lower than the second threshold value when the input voltage changes from a positive value to zero, the fast lower switch, the slow upper switch and the slow lower switch are not conducted according to the second control signal, the third control signal and the fourth control signal set by the controller, and at least one of the reference voltage command and the reference current command is increased by the controller. In addition, a duty cycle of the first control signal is gradually increased, and the fast upper switch is intermittently conducted. Consequently, the change rate of the terminal voltage is adjusted according to the predetermined voltage slope.

In accordance with another aspect of the present disclosure, a power conversion device is provided. The power conversion device includes at least one totem-pole power factor correction circuit. The totem-pole power factor correction circuit receives an input voltage and an input current and accordingly provides an output voltage and an output current. The totem-pole power factor correction circuit includes a fast arm circuit, a slow arm circuit, a capacitor filter circuit and a controller. The fast arm circuit includes a fast upper switch and a fast lower switch connected in series. The slow arm circuit includes a slow upper switch and a slow lower switch connected in series. The slow upper switch and the slow lower switch are electrically connected with a node. In addition, there is a terminal voltage between the node and a reference potential point. The capacitor filter circuit is electrically connected with the fast arm circuit and the slow arm circuit. The capacitor filter circuit has an equivalent capacitance value. The controller is electrically connected with the fast arm circuit and the slow arm circuit. The controller outputs a first control signal, a second control signal, a third control signal and a fourth control signal to respectively control operations of the fast upper switch, the fast lower switch, the slow upper switch and the slow lower switch. If the input voltage is greater than a first threshold value and lower than a second threshold value when the input voltage changes from a negative value to zero, the fast upper switch, the slow upper switch and the slow lower switch are not conducted according to the first control signal, the third control signal and the fourth control signal set by the controller, and at least one of a reference voltage command and a reference current command is increased by the controller. In addition, a duty cycle of the second control signal is gradually increased, and the fast lower switch is intermittently conducted. Consequently, a change rate of the terminal voltage is adjusted according to a predetermined voltage slope. If the input voltage is greater than the first threshold value and lower than the second threshold value when the input voltage changes from a positive value to zero, the fast lower switch, the slow upper switch and the slow lower switch are not conducted according to the second control signal, the third control signal and the fourth control signal set by the controller, and at least one of the reference voltage command and the reference current command is increased by the controller. In addition, a duty cycle of the first control signal is gradually increased, and the fast upper switch is intermittently conducted. Consequently, the change rate of the terminal voltage is adjusted according to the predetermined voltage slope.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a circuitry topology of a totem-pole power factor correction circuit according to an embodiment of the present disclosure;

FIG. 2 is a schematic timing waveform diagram illustrating associated signals of the totem-pole power factor correction circuit shown in FIG. 1;

FIG. 3 is a schematic circuit diagram illustrating the detailed circuitry topology of a controller of the totem-pole power factor correction circuit shown in FIG. 1;

FIG. 4 schematically illustrates the architecture of a power conversion device according to an embodiment of the present disclosure; and

FIG. 5 is a schematic timing waveform diagram illustrating associated signals of the totem-pole power factor correction circuits of the power conversion device shown in FIG. 4.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

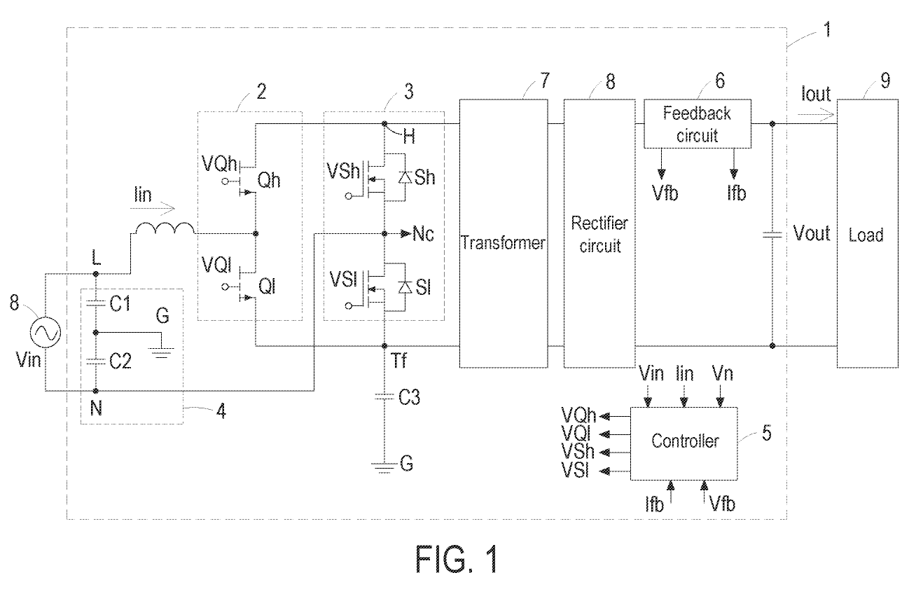

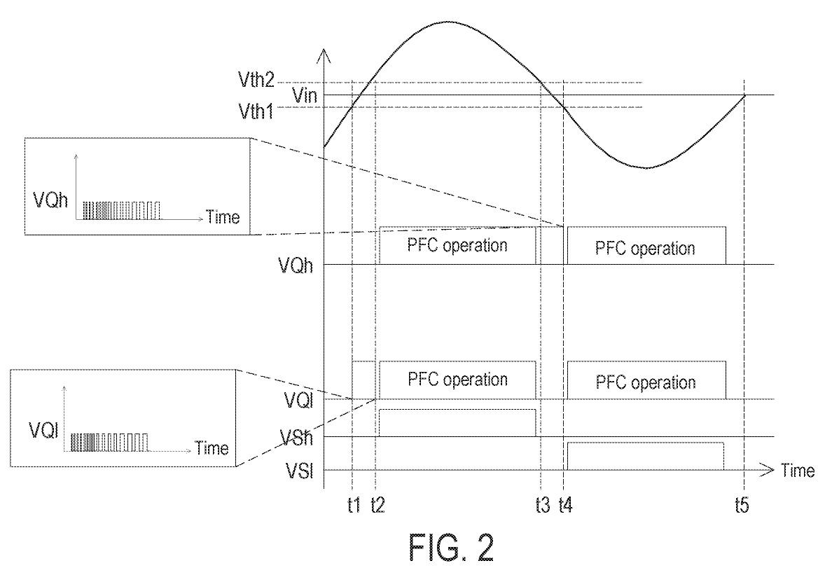

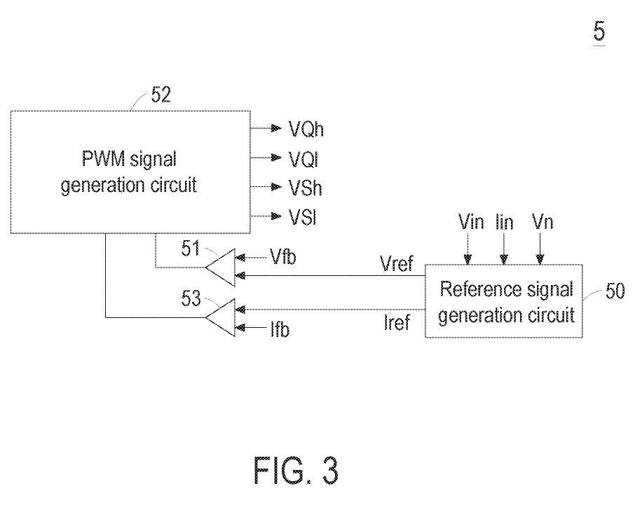

Please refer to FIGS. 1, 2 and 3. FIG. 1 is a schematic circuit diagram illustrating a circuitry topology of a totem-pole power factor correction circuit according to an embodiment of the present disclosure. FIG. 2 is a schematic timing waveform diagram illustrating associated signals of the totem-pole power factor correction circuit shown in FIG. 1. FIG. 3 is a schematic circuit diagram illustrating the detailed circuitry topology of a controller of the totem-pole power factor correction circuit shown in FIG. 1.

The input terminal of the totem-pole power factor correction circuit 1 is electrically connected with an input power supply 8. The output terminal of the totem-pole power factor correction circuit 1 is electrically connected with a load 9. The totem-pole power factor correction circuit 1 receives an input voltage Vin and an input current Iin from the AC input power supply 8 through the input terminal (L, N). After a power factor correction is performed, a DC output voltage Vout and an output current Iout are outputted from the output terminal of the totem-pole power factor correction circuit 1.

In an embodiment, the totem-pole power factor correction circuit 1 includes a fast arm circuit 2, a slow arm circuit 3, a capacitor filter circuit 4, a controller 5, a feedback circuit 6, a transformer 7 and a rectifier circuit 8.

The fast arm circuit 2 is electrically connected with the input power supply 8. The fast arm circuit 2 includes at least one bridge arm circuit. Each bridge arm circuit includes a fast upper switch Qh and a fast lower switch Ql connected in series. The slow arm circuit 3 is electrically connected with the fast arm circuit 2 in parallel. The slow arm circuit 3 includes a slow upper switch Sh and a slow lower switch Sl connected in series. The slow upper switch Sh and the slow lower switch Sl are electrically connected with a node Nc. In addition, there is a terminal voltage Vn between the node Nc and a reference potential point. For example, the reference potential point is a ground terminal G, a high voltage terminal H connected between the first terminal of the fast arm circuit 2 and the first terminal of the slow arm circuit 3, and a low voltage terminal Tf connected between the second terminal of the fast arm circuit 2 and the second terminal of the slow arm circuit 3.

The capacitor filter circuit 4 is electrically connected with the fast arm circuit 2 and the slow arm circuit 3. In an embodiment, the capacitor filter circuit 4 includes a first Y capacitor C1 and a second Y capacitor C2. The two terminals of each of the first Y capacitor C1 and the second Y capacitor C2 are electrically connected with the input terminal (L, N) and the ground terminal G. In addition, the node between the first Y capacitor C1 and the second Y capacitor C2 is electrically connected with the ground terminal G. In an embodiment, the totem-pole power factor correction circuit 1 further includes a third Y capacitor C3. The first terminal of the third Y capacitor C3 is electrically connected with the low voltage terminal Tf between the fast arm circuit 2 and the slow arm circuit 3. The second terminal of the third Y capacitor C3 is electrically connected with the ground terminal G.

The transformer 7 includes a primary winding (not shown) and a secondary winding (not shown). The primary winding is electrically connected with the slow arm circuit 3. The electric energy received by the primary winding is transmitted to the secondary winding according to an electromagnetic coupling effect.

The rectifier circuit 8 is electrically connected with the secondary winding of the transformer 7. After the electric energy from the secondary winding of the transformer 7 is rectified by the rectifier circuit 8, the output voltage Vout and the output current Iout are generated.

The controller 5 is electrically connected with the input terminal of the totem-pole power factor correction circuit 1, the reference potential point, the fast arm circuit 2 and the slow arm circuit 3. The controller 5 is configured to detect the input voltage Vin and determine whether the input voltage Vin is within a zero-crossing interval according to the detection result. For example, the controller 5 determines whether the input voltage Vin is within a voltage range near 0V, or in a region where the input voltage Vin transitions from negative to positive through 0V, or in a region where the input voltage Vin transitions from positive to negative through 0V.

Please refer to FIG. 2. For example, in the time interval between the time point t1 and the time point t2 or the time interval between the time point t3 and the time point t4, the AC input voltage Vin lies within a voltage range between a first threshold value Vth1 and a second threshold value Vth2. Consequently, in the time interval between the time point t1 and the time point t2 or the time interval between the time point t3 and the time point t4, the input voltage Vin is in the zero-crossing interval. According to the input voltage Vin and the terminal voltage Vn, the controller 5 outputs a first control signal VQh, a second control signal VQl, a third control signal VSh and a fourth control signal VSl to respectively control the operations of the fast upper switch Qh, the fast lower switch Ql, the slow upper switch Sh and the slow lower switch Sl.

The feedback circuit 6 is electrically connected between the rectifier circuit 8 and the output terminal of the totem-pole power factor correction circuit 1. The feedback circuit 6 is configured to detect the output voltage Vout and the output current Iout. According to the detection results, the feedback circuit 6 correspondingly generates a voltage feedback signal Vfb and a current feedback signal Ifb.

As shown in FIG. 3, in some embodiments, the controller 5 includes a reference signal generation circuit 50, a first comparator 51 and a pulse width modulation (PWM) signal generation circuit 52.

The reference signal generation circuit 50 is electrically connected with the input terminal of the totem-pole power factor correction circuit 1 and the reference potential point. The reference signal generation circuit 50 is configured to detect the input voltage Vin and the terminal voltage Vn. Furthermore, when the input voltage Vin is within the zero-crossing interval, the reference signal generation circuit 50 generates a reference voltage command Vref according to a predetermined voltage slope and the terminal voltage Vn.

The first comparator 51 is electrically connected with the reference signal generation circuit 50 and the feedback circuit 6. The first comparator 51 compares the reference voltage command Vref with the voltage feedback signal Vfb. According to the comparison result, the first comparator 51 outputs a first comparison signal.

The PWM signal generation circuit 52 is electrically connected with the first comparator 51, the fast upper switch Qh, the fast lower switch Ql, the slow upper switch Sh and the slow lower switch Sl. The PWM signal generation circuit 52 generates the first control signal VQh, the second control signal VQl, the third control signal VSh and the fourth control signal VSl to respectively control the operations of the fast upper switch Qh, the fast lower switch Ql, the slow upper switch Sh and the slow lower switch Sl. Furthermore, according to the first comparison signal, the PWM signal generation circuit 52 adjusts or sets the first control signal VQh and the second control signal VQl to control the operations of the fast upper switch Qh and the fast lower switch Ql. Consequently, the change rate of the terminal voltage Vn is adjusted according to the predetermined voltage slope.

In some embodiments, the reference signal generation circuit 50 further detects the input current Iin. When the input voltage Vin is within the zero-crossing interval, the reference signal generation circuit 50 generates a reference current command Iref according to the detection result of the input current and the predetermined voltage slope.

The controller 5 further includes a second comparator 53. The second comparator 53 is electrically connected with the reference signal generation circuit 50 and the feedback circuit 6. The second comparator 53 compares the reference current command Iref with the current feedback signal Ifb. According to the comparison result, the second comparator 53 outputs a second comparison signal. According to the second comparison signal, the PWM signal generation circuit 52 generates the first control signal VQh, the second control signal VQl, the third control signal VSh and the fourth control signal VSl to respectively control the operations of the fast upper switch Qh, the fast lower switch Ql, the slow upper switch Sh and the slow lower switch Sl. Furthermore, according to the second comparison signal, the PWM signal generation circuit 52 adjusts or sets the first control signal VQh and the second control signal VQl to control the operations of the fast upper switch Qh and the fast lower switch Ql. Consequently, the change rate of the terminal voltage Vn is adjusted according to the predetermined voltage slope.

In an embodiment, if the input voltage Vin is greater than the first threshold value Vth1 and lower than the second threshold value Vth2, the controller 5 determines that the input voltage Vin is within the zero-crossing interval. The first threshold value Vth1 and the second threshold value Vth2 are appropriate voltages for determining whether the input voltage Vin is within the zero-crossing interval.

In an embodiment, when the input voltage Vin changes from a negative value to 0V, if the input voltage Vin is greater than the first threshold value Vth1 and lower than the second threshold value Vth2, the controller 5 determines that the input voltage Vin is within the zero-crossing interval. Meanwhile, the reference signal generation circuit 50 will gradually increase the reference voltage command Vref and/or the reference current command Iref. Consequently, the duty cycle of the second control signal VQ1 gradually increases, and the change rate of the terminal voltage Vn is adjusted according to the predetermined voltage slope.

For example, in case that the reference potential point is the ground terminal G, the terminal voltage Vn refers to the voltage difference between the input terminal N and the ground terminal G. The fast upper switch Qh, the slow upper switch Sh and the slow lower switch Sl are not conducted according to the first control signal VQh, the third control signal VSh and the fourth control signal VSl set by the controller 5. In addition, the duty cycle of the second control signal VQ1 is gradually increased by the controller 5, and the fast lower switch Ql is intermittently conducted. In this way, the terminal voltage Vn decreases to zero according to the predetermined voltage slope. That is, the voltage level of the input terminal N and the voltage level of the ground terminal G are equal.

For example, in case that the reference potential point is the high voltage terminal H, the terminal voltage Vn refers to the voltage difference between the input terminal N and the high voltage terminal H. The fast upper switch Qh, the slow upper switch Sh and the slow lower switch Sl are not conducted according to the first control signal VQh, the third control signal VSh and the fourth control signal VSl set by the controller 5. In addition, the duty cycle of the second control signal VQ1 is gradually increased by the controller 5, and the fast lower switch Ql is intermittently conducted. In this way, the terminal voltage Vn increases to the output voltage Vout according to the predetermined voltage slope. That is, the voltage level of the input terminal N and the voltage level of the ground terminal G are equal.

In an embodiment, when the input voltage Vin changes from a positive value to 0V, if the input voltage Vin is greater than the first threshold value Vth1 and lower than the second threshold value Vth2, the controller 5 determines that the input voltage Vin is within the zero-crossing interval. Meanwhile, the reference signal generation circuit 50 will gradually increase the reference voltage command Vref and/or the reference current command Iref. Consequently, the duty cycle of the first control signal VQh gradually increases, and the change rate of the terminal voltage Vn is adjusted according to the predetermined voltage slope.

For example, in case that the reference potential point is the ground terminal G, the terminal voltage Vn refers to the voltage difference between the input terminal N and the ground terminal G. The fast lower switch Ql, the slow upper switch Sh and the slow lower switch Sl are not conducted according to the second control signal VQl, the third control signal VSh and the fourth control signal VSl set by the controller 5. In addition, the duty cycle of the first control signal VQh is gradually increased by the controller 5, and the fast upper switch Qh is intermittently conducted. In this way, the terminal voltage Vn decreases to zero according to the predetermined voltage slope. That is, the voltage level of the input terminal N and the voltage level of the ground terminal G are equal.

For example, in case that the reference potential point is the high voltage terminal H, the terminal voltage Vn refers to the voltage difference between the input terminal N and the high voltage terminal H. The fast lower switch Ql, the slow upper switch Sh and the slow lower switch Sl are not conducted according to the second control signal VQl, the third control signal VSh and the fourth control signal VSl set by the controller 5. In addition, the duty cycle of the first control signal VQh is gradually increased by the controller 5, and the fast upper switch Qh is intermittently conducted. In this way, the terminal voltage Vn increases to the output voltage Vout according to the predetermined voltage slope. That is, the voltage level of the input terminal N and the voltage level of the ground terminal G are equal.

In case that the absolute value of the input voltage Vin is lower than the absolute value of the first threshold Vth1 or the absolute value of the second threshold Vth2, the slow high-side switch Sh and the slow low-side switch Sl are not conducted according to the third control signal VSh and the fourth control signal VSl set by the controller 5. By utilizing the first control signal VQh, the second control signal VQl, the third control signal VSh, and the fourth control signal VSl to control the operations of the fast upper switch Qh, the fast lower switch Ql, the slow upper switch Sh and the slow lower switch Sl, the terminal voltage Vn is adjusted to the desired voltage level according to a predetermined voltage slope.

The totem-pole power factor correction circuit 1 can be operated in the normal power factor correction mode. For example, in the time interval between the time point t2 and the time point t3 (see FIG. 2), the input voltage Vin is in the positive half cycle, the slow upper switch Sh is maintained in the conducting state, the slow lower switch Sl is maintained in the non-conducting state, and the fast upper switch Qh and the fast lower switch Ql are alternately conducted. For example, in the time interval between the time point t4 and the time point t5 (see FIG. 2), the input voltage Vin is in the negative half cycle, the slow upper switch Sh is maintained in the non-conducting state, the slow lower switch Sl is maintained in the conducting state, and the fast upper switch Qh and the fast lower switch Ql are alternately conducted.

When measuring the leakage current of the totem-pole power factor correction circuit 1, a measuring instrument may be connected to the node Nc and the ground terminal G to measure the leakage current. In addition, the following relationship may be obtained: Ilk = Cy×(dVn/dt), wherein Ilk is the leakage current measured by the node Nc and the ground terminal G, Cy is the equivalent capacitance value between the node Nc and the ground terminal G, and dVn/dt is the rate of change of the terminal voltage Vn over time (i.e., the change rate of the terminal voltage Vn).

In the above relationship, the equivalent capacitance value Cy of the capacitor filter circuit 4 is a known value. By controlling the change rate of the terminal voltage Vn with time, the leakage current Ilk can be controlled to be within the leakage inductance current allowable value Ilim to meet the safety regulations. For example, the change slope of the terminal voltage Vn at the charging moment and the discharging moment of the capacitor filter circuit 4 multiplied by the equivalent capacitance value Cy is lower than the leakage current allowable value Ilim (i.e., the absolute value of the change slope dVn/dt multiplied by the equivalent capacitance value Cy is lower than the leakage current allowable value Ilim).

As mentioned above, the controller 5 detects the input voltage Vin and the terminal voltage Vn. In case that the absolute value of the input voltage Vin is lower than the absolute value of the first threshold Vth1 or the absolute value of the second threshold Vth2, the controller 5 adjusts or sets the first control signal VQh and the second control signal VQl to control the fast upper switch Qh and the fast lower switch Ql according to the predetermined voltage slope and the terminal voltage Vn. Consequently, the change rate of the terminal voltage Vn is adjusted according to the predetermined voltage slope. In this way, the totem-pole power factor correction circuit 1 can suppress the leakage current to be within the leakage inductance current allowable value Ilim. By suppressing the leakage current of the totem-pole power factor correction circuit 1, the design constraint of requiring a high capacitance value in the capacitor filtering circuit 4 can be avoided.

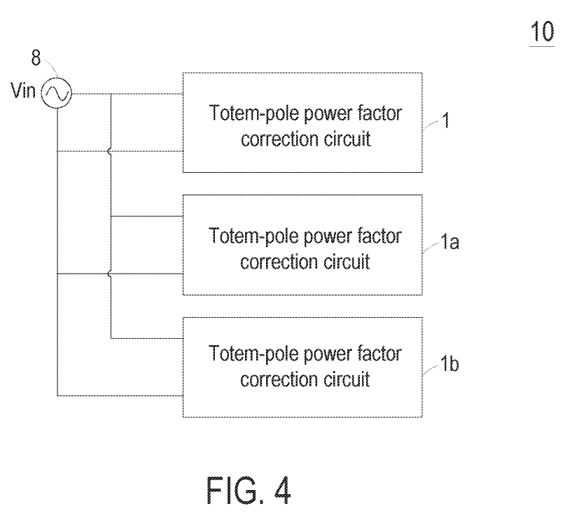

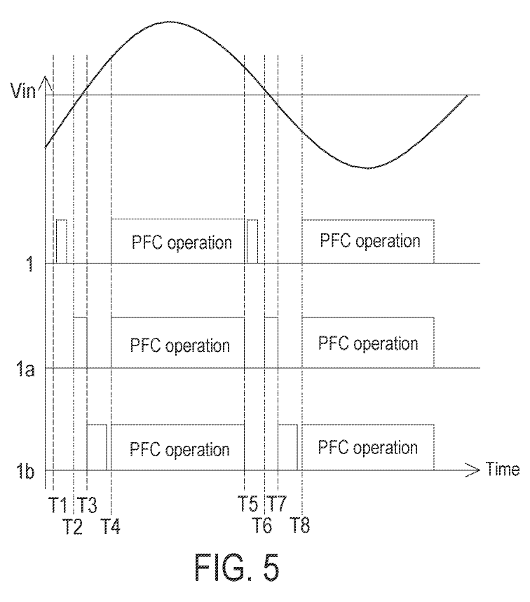

The present disclosure further provides a power conversion device. FIG. 4 schematically illustrates the architecture of a power conversion device according to an embodiment of the present disclosure. FIG. 5 is a schematic timing waveform diagram illustrating associated signals of the totem-pole power factor correction circuits of the power conversion device shown in FIG. 4.

The power conversion device 10 includes at least two totem-pole power factor correction circuits. For example, as shown in FIG. 4, the power conversion device 10 includes three totem-pole power factor correction circuits, i.e., a first totem-pole power factor correction circuit 1, a second totem-pole power factor correction circuit 1a and a third totem-pole power factor correction circuit 1b. The first totem-pole power factor correction circuit 1, the second totem-pole power factor correction circuit 1a and the third totem-pole power factor correction circuit 1b are connected with each other in parallel. In addition, these totem-pole power factor correction circuits 1, 1a and 1b are connected with the input power supply 8. Each of the totem-pole power factor correction circuits 1, 1a and 1b has the capability of suppressing the leakage current to be within the leakage inductance current allowable value Ilim.

In an embodiment, if the controller 5 of the first totem-pole power factor correction circuit 1 determines that the input voltage Vin is within the zero-crossing interval, the controller 5 adjusts or sets the first control signal VQh and the second control signal VQl to control the operations of the fast upper switch Qh and the fast lower switch Ql according to the predetermined voltage slope and the terminal voltage Vn. Consequently, the change rate of the terminal voltage Vn is adjusted according to the predetermined voltage slope. The operations of the first totem-pole power factor correction circuit 1 can be seen in the waveform of FIG. 5 in the time interval between the time point T1 and the time point T2 and the time interval between the time point T5 and the time point T6.

Similarly, if the controller 5 of the second totem-pole power factor correction circuit 1a determines that the input voltage Vin is within the zero-crossing interval, the controller 5 adjusts or sets the first control signal VQh and the second control signal VQl to control the operations of the fast upper switch Qh and the fast lower switch Ql according to the predetermined voltage slope and the terminal voltage Vn. Consequently, the change rate of the terminal voltage Vn is adjusted according to the predetermined voltage slope. The operations of the second totem-pole power factor correction circuit 1a can be seen in the waveform of FIG. 5 in the time interval between the time point T2 and the time point T3 and the time interval between the time point T6 and the time point T7.

Similarly, if the controller 5 of the third totem-pole power factor correction circuit 1b determines that the input voltage Vin is within the zero-crossing interval, the controller 5 adjusts or sets the first control signal VQh and the second control signal VQl to control the operations of the fast upper switch Qh and the fast lower switch Ql according to the predetermined voltage slope and the terminal voltage Vn. Consequently, the change rate of the terminal voltage Vn is adjusted according to the predetermined voltage slope. The operations of the third totem-pole power factor correction circuit 1b can be seen in the waveform of FIG. 5 in the time interval between the time point T3 and the time point T4 and the time interval between the time point T7 and the time point T8.

Furthermore, the time segments of adjusting the change rate of the terminal voltage Vn according to the predetermined voltage slope for the totem-pole power factor correction circuits 1, 1a and 1b are not overlapping or only partially overlapping. In this way, the leakage current spike can be effectively reduced.

From the above descriptions, the present disclosure provides a totem-pole power factor correction circuit and an associated power conversion device. If the controller of the totem-pole power factor correction circuit determines that the input voltage is within the zero-crossing interval, the controller adjusts or sets the operations of the fast upper switch and the fast lower switch according to the predetermined voltage slope and the terminal voltage. Consequently, the change rate of the terminal voltage is adjusted according to the predetermined voltage slope. Due to the circuitry design, the totem-pole power factor correction circuit has the capability of suppressing the leakage current to be within the leakage inductance current allowable value.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures .

What is claimed is:

1. A totem-pole power factor correction circuit, configured to receive an input voltage and an input current and accordingly provide an output voltage and an output current, comprising:
a fast arm circuit comprising a fast upper switch and a fast lower switch connected in series;
a slow arm circuit comprising a slow upper switch and a slow lower switch connected in series, wherein the slow upper switch and the slow lower switch are electrically connected with a node, and there is a terminal voltage between the node and a reference potential point;
a capacitor filter circuit electrically connected with the fast arm circuit and the slow arm circuit, wherein the capacitor filter circuit has an equivalent capacitance value; and
a controller electrically connected with the fast arm circuit and the slow arm circuit, wherein the controller outputs a first control signal, a second control signal, a third control signal and a fourth control signal to respectively control operations of the fast upper switch, the fast lower switch, the slow upper switch and the slow lower switch,
wherein if the input voltage is greater than a first threshold value and lower than a second threshold value when the input voltage changes from a negative value to zero, the fast upper switch, the slow upper switch and the slow lower switch are not conducted according to the first control signal, the third control signal and the fourth control signal set by the controller, and at least one of a reference voltage command and a reference current command is increased by the controller, wherein a duty cycle of the second control signal is gradually increased, and the fast lower switch is intermittently conducted, so that a change rate of the terminal voltage is adjusted according to a predetermined voltage slope,
wherein if the input voltage is greater than the first threshold value and lower than the second threshold value when the input voltage changes from a positive value to zero, the fast lower switch, the slow upper switch and the slow lower switch are not conducted according to the second control signal, the third control signal and the fourth control signal set by the controller, and at least one of the reference voltage command and the reference current command is increased by the controller, wherein a duty cycle of the first control signal is gradually increased, and the fast upper switch is intermittently conducted, so that the change rate of the terminal voltage is adjusted according to the predetermined voltage slope.

2. The totem-pole power factor correction circuit according to claim 1, wherein the totem-pole power factor correction circuit further comprises a feedback circuit electrically connected with an output terminal of the totem-pole power factor correction circuit and configured to generate a voltage feedback signal and a current feedback signal according to a detection result of detecting the output voltage and the output current.

3. The totem-pole power factor correction circuit according to claim 2, wherein the controller comprises:
a reference signal generation circuit electrically connected with an input terminal of the totem-pole power factor correction circuit and the reference potential point, and configured to detect the input voltage and the terminal voltage, wherein when the input voltage is within a zero-crossing interval, the reference signal generation circuit calculates the predetermined voltage slope according to an allowable leakage inductance current value and the equivalent capacitance value, and the reference signal generation circuit generates the reference voltage command according to the predetermined voltage slope;
a first comparator electrically connected with the reference signal generation circuit and the feedback circuit and configured to output a first comparison signal according to a result of comparing the reference voltage command with the voltage feedback signal; and
a PWM signal generation circuit electrically connected with the first comparator, the fast upper switch, the fast lower switch, the slow upper switch and the slow lower switch, and configured to generate the first control signal, the second control signal, the third control signal and the fourth control signal, wherein according to the first comparison signal, the PWM signal generation circuit adjusts or sets the first control signal and the second control signal to control the operations of the fast upper switch and the fast lower switch, so that the change rate of the terminal voltage is adjusted according to the predetermined voltage slope.

4. The totem-pole power factor correction circuit according to claim 3, wherein the reference signal generation circuit further detects the input current, wherein when the input voltage is within the zero-crossing interval, the reference signal generation circuit generates the reference current command according to a detection result of the input current and the predetermined voltage slope.

5. The totem-pole power factor correction circuit according to claim 4, wherein the controller further comprises a second comparator electrically connected with the reference signal generation circuit and the feedback circuit and configured to output a second comparison signal according to a result of comparing the reference current command with the current feedback signal, wherein according to the second comparison signal, the PWM signal generation circuit adjusts or sets the first control signal and the second control signal to control the operations of the fast upper switch and the fast lower switch, so that the change rate of the terminal voltage is adjusted according to the predetermined voltage slope.

6. The totem-pole power factor correction circuit according to claim 1, wherein if the input voltage is greater than the first threshold value and lower than the second threshold value, the controller determines that the input voltage is within a zero-crossing interval.

7. A power conversion device, comprising:
at least one totem-pole power factor correction circuit, configured to receive an input voltage and an input current and accordingly provide an output voltage and an output current, wherein each of the at least one totem-pole power factor correction circuit comprises:
a fast arm circuit comprising a fast upper switch and a fast lower switch connected in series;
a slow arm circuit comprising a slow upper switch and a slow lower switch connected in series, wherein the slow upper switch and the slow lower switch are electrically connected with a node, and there is a terminal voltage between the node and a reference potential point;
a capacitor filter circuit electrically connected with the fast arm circuit and the slow arm circuit, wherein the capacitor filter circuit has an equivalent capacitance value; and
a controller electrically connected with the fast arm circuit and the slow arm circuit, wherein the controller outputs a first control signal, a second control signal, a third control signal and a fourth control signal to respectively control operations of the fast upper switch, the fast lower switch, the slow upper switch and the slow lower switch,
wherein if the input voltage is greater than a first threshold value and lower than a second threshold value when the input voltage changes from a negative value to zero, the fast upper switch, the slow upper switch and the slow lower switch are not conducted according to the first control signal, the third control signal and the fourth control signal set by the controller, and at least one of a reference voltage command and a reference current command is increased by the controller, wherein a duty cycle of the second control signal is gradually increased, and the fast lower switch is intermittently conducted, so that a change rate of the terminal voltage is adjusted according to a predetermined voltage slope,
wherein if the input voltage is greater than the first threshold value and lower than the second threshold value when the input voltage changes from a positive value to zero, the fast lower switch, the slow upper switch and the slow lower switch are not conducted according to the second control signal, the third control signal and the fourth control signal set by the controller, and at least one of the reference voltage command and the reference current command is increased by the controller, wherein a duty cycle of the first control signal is gradually increased, and the fast upper switch is intermittently conducted, so that the change rate of the terminal voltage is adjusted according to the predetermined voltage slope.

8. The power conversion device according to claim 7, wherein the at least one totem-pole power factor correction circuit includes a plurality of totem-pole power factor correction circuits connected in parallel, wherein if the controller of any of the plurality of totem-pole power factor correction circuits determines that the input voltage is within a zero-crossing interval, the controller adjusts or sets the first control signal and the second control signal to control operations of the fast upper switch and the fast lower switch, so that the change rate of the terminal voltage is adjusted according to the predetermined voltage slope, wherein the changes rates of the terminal voltages for the plurality of totem-pole power factor correction circuits are adjusted according to the predetermined voltage slope at different time segments.
